(19) United States
(12) Patent Application Publication
(10) Pub. No.: US 2005/0111651 A1
(43) Pub. Date: May 26, 2005

(54) Script translation

(76) Inventors: Armando Chavez, Cupertino, CA (US); Janaki Kumar, Palo Alto, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/719,560

(22) Filed: Nov. 21, 2003

(51) Int. Cl. H04M 3/00; H04M 7/00; G06F 15/16

(52) U.S. Cl. 379/265.01; 379/265.04; 379/219; 709/202; 709/227

(57) ABSTRACT

One embodiment of the invention provides a graphical user interface (GUI) for use by a designer in preparing a translation of a script that may later be displayed to and read by a user during an interactive session with another person. In this embodiment, the GUI includes first and second sets of script areas. The first set of script areas are each capable of providing a textual display of a distinct portion of the script in a first language. The second set of script areas are each capable of providing a textual display of a distinct portion of the script in a second language. Each script area in the first set has a spatial relationship with a script area in the second set that corresponds to the same distinct portion of the script.

### TECHNICAL FIELD

This invention relates to the translation of interactive scripts for use in computer systems.

### BACKGROUND

In recent years, telephone call centers have become much more widespread. The call centers manage many efforts, and call-center agents working in these centers often place thousands of calls to various customers in different regions of the country. These agents often use headsets to speak with customers while they concurrently enter information relating to the customers into a computer workstation.

Many call-center agents utilize scripts when interacting with customers. These scripts are displayed on the agents' computer workstations. The agents can simply read these scripts to the customers rather than having to commit a large amount of information to memory. Scripts are very helpful in such situations, because they can provide the agents with detailed information that is tailored to the type of interaction.

Because call centers are now much more widespread, call-center agents must interact with customers who speak a variety of different languages. For example, in a product support call center, call-center agents may need to field support questions from customers who are located in the United States, Canada, or Mexico. Therefore, in order for interactive scripts to be most useful in situations such as these, they must be translated into a variety of different languages. Once they have been translated, they can be displayed to the call-center agents in the appropriate languages while the agents interact with customers.

Often, script designers translate interactive scripts at design time. Once the scripts have been translated, they are then ready to be used by call-center agents at run-time, when they interact with customers. Typically, interactive scripts will include a number of script elements. For example, an interactive script could include an introduction script element, a question script element, an answer script element, and a conclusion script element. Each of these script elements will be associated with text in a given language, such as English. To translate the entire script, a script designer must translate the text associated with each of the script elements.

Often, script designers have to translate the text associated with these script elements in several steps. For example, they may need to first translate text for a first script element in a first translation step (or window), and then translate the text for the remaining script elements in steps. The Siebel® SmartScript product allows designers to translate scripts using this type of multi-step, or piecemeal, process. A multi-step translation process can potentially add extra overhead, and can also increase the possibility that a script designer may inadvertently forget to translate the text associated with a particular script element.

### SUMMARY

Various embodiments of the present invention are provided herein. One embodiment provides a graphical user interface (GUI) for use by a designer in preparing a translation of a script that may later be displayed to and read by a user during an interactive session with another person. In this embodiment, the GUI includes first and second sets of script areas. The first set of script areas are each capable of providing a textual display of a distinct portion of the script in a first language. The second set of script areas are each capable of providing a textual display of a distinct portion of the script in a second language. Each script area in the first set has a spatial relationship with a script area in the second set that corresponds to the same distinct portion of the script.

There may be various benefits or advantages to certain embodiments of the present invention. For example, in one embodiment, a graphical user interface (GUI) displays each element of an interactive script to a script designer in an original language, such as English.

The display of the entire script in the original language facilitates the script translation process. A script designer is capable of viewing all of the script elements in a particular viewing area, and is then capable of translating each of these elements into a new language, such as Spanish. By displaying all of the script elements in the viewing area, the script designer is much less likely to forget translating any of the script elements into the new language.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is an example of a graphical user interface (GUI) to display script translation information.

FIG. 2 is an example of a design-time GUI to display a script graph.

FIG. 3A is an example of a design-time GUI to display script information in English.

FIG. 3B is an example of a design-time GUI to display additional script text in English.

FIG. 4 is an example of a design-time GUI to display script translation information.

FIG. 5 is an example of a run-time GUI to display a script to a call-center agent in English.

FIG. 6 is an example of a run-time GUI to display the script shown in FIG. 5 translated into Spanish.

FIG. 7 shows a block diagram of a computing system that can be utilized for displaying the various GUI's shown in FIG. 1 through FIG. 6, according to one embodiment.

### DETAILED DESCRIPTION

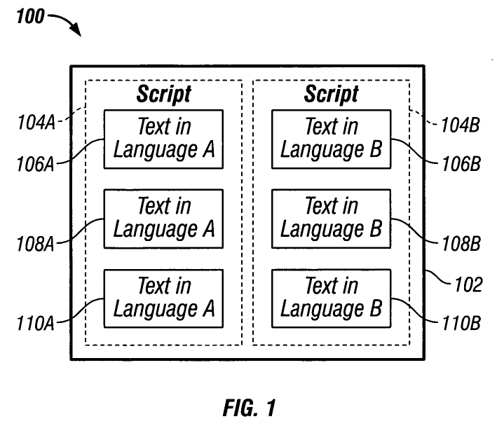

FIG. 1 is an example of a graphical user interface (GUI) 100 for use by a designer in preparing a translation of a script that may be displayed to and read by a user, such as a call-center agent, during an interactive session with another person, such as a customer. The GUI 100 includes a screen 102 that shows two screen areas 104A and 104B to display the script in different languages. The screen area 104A contains script areas 106A, 108A, and 110A that are each capable of providing a textual display of a distinct portion of the script in a first language “A,” such as English. The screen area 104B contains script areas 106B, 108B, and 110B that are each capable of providing a textual display of a distinct portion of the script in a second language “B,” such as Spanish. Each script area 106A, 108A, and 110A has a spatial relationship with the script area 106B, 108B, or 110B that corresponds to the same distinct portion of the script.

Each of the script areas 106A, 108A, and 110A contain text in a language “A.” These areas show the textual information that is associated with the script. The script areas 106B, 108B, and 110B contain text in a language “B.” These areas also show the textual information associated with the script. Each of the script areas in the screen area 104A is associated with one of the script areas in the screen area 104B. For example, as shown in FIG. 1, the script area 106A is associated with the script area 106B. The text shown in the script area 106A (language “A”) is a translation of the text shown in the script area 106B (language “B”).

In one embodiment, a script designer uses the GUI 100 shown in FIG. 1 to translate a script from language “A” into language “B.” In this embodiment, the text for each of the script areas 106A, 108A, and 110A are displayed to the script designer in language “A.” The script designer then inputs the text for each portion of the script into the script areas 106B, 108B, and 110B in language “B.” In this fashion, the script designer can efficiently enter translation information for all text associated with these scripts in one screen area 102.

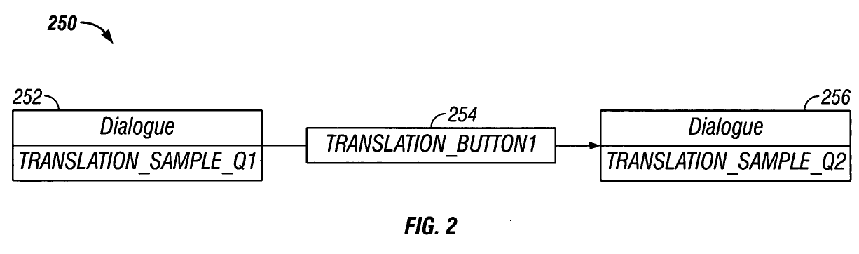

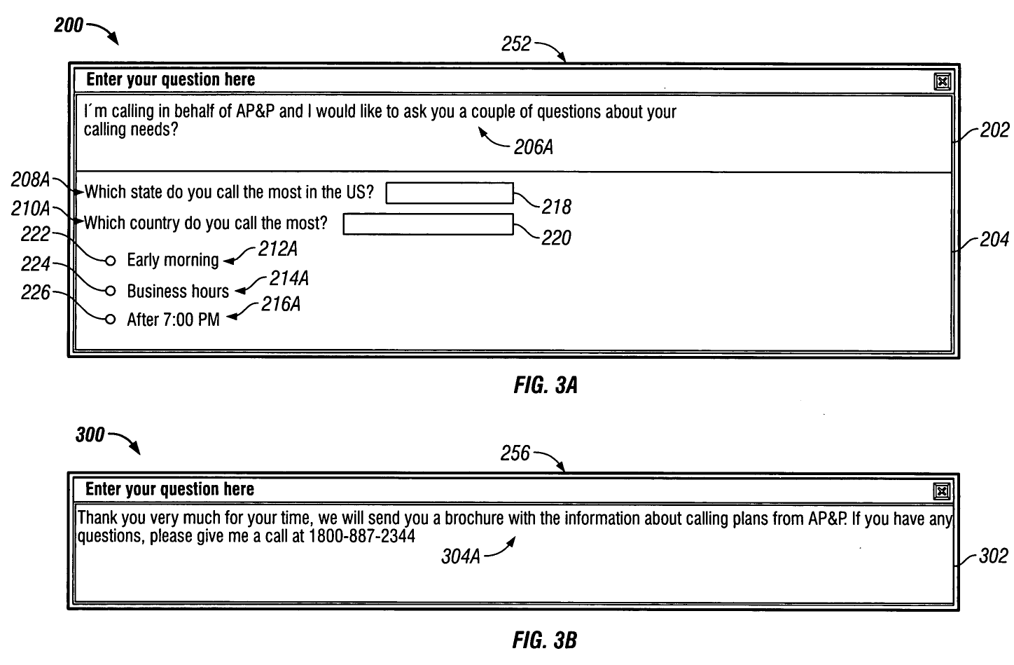

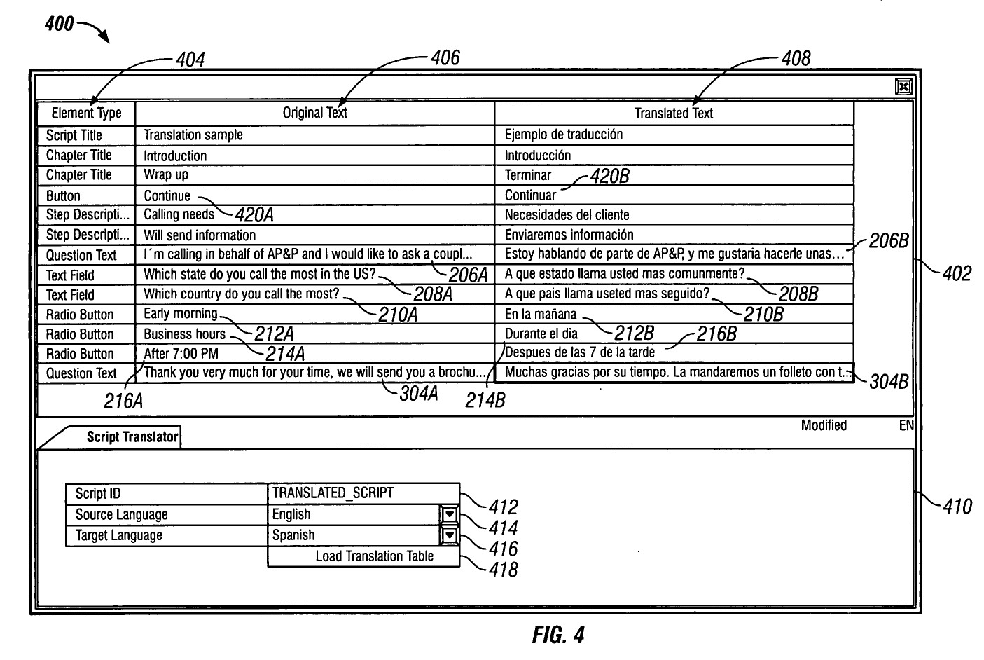

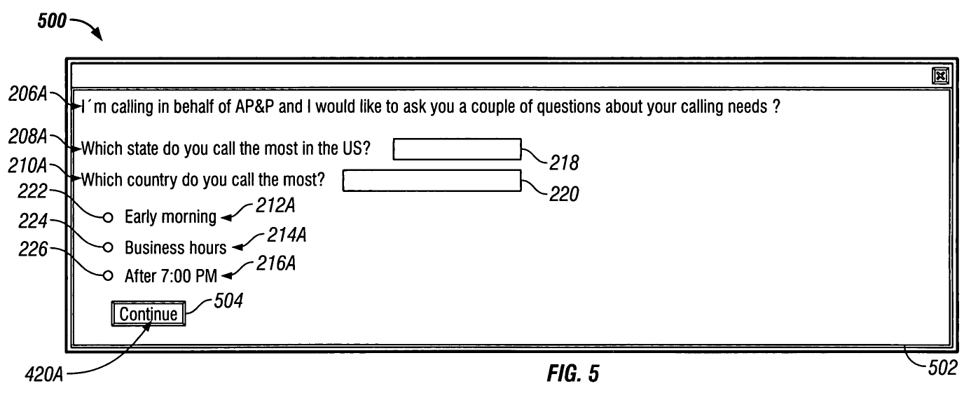

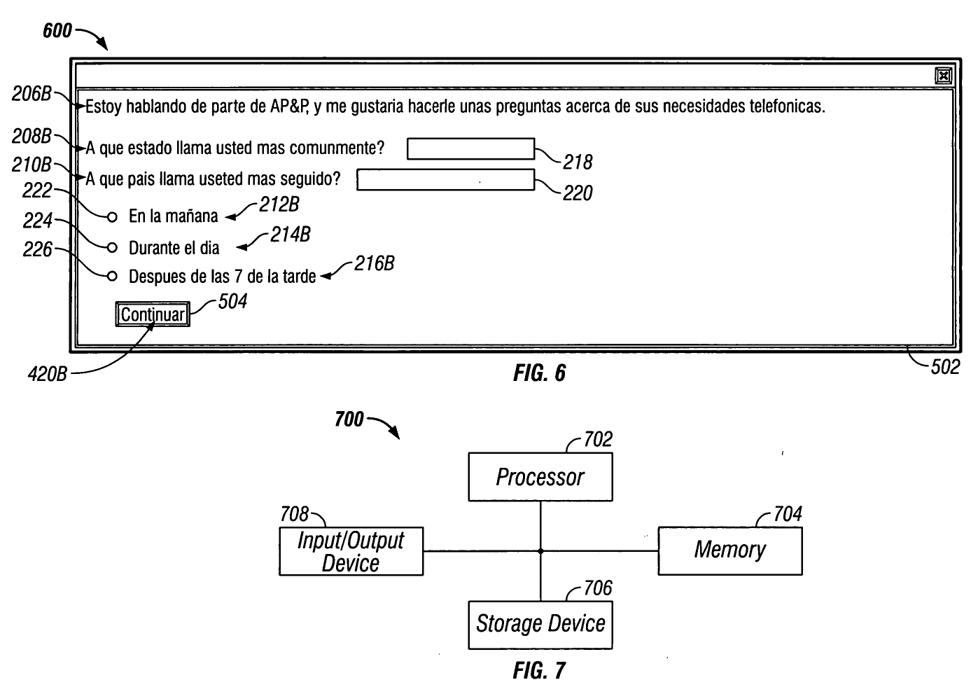

FIG. 2, FIG. 3A, FIG. 3B, and FIG. 4 show various design-time GUI's that display script information to a designer. FIG. 5 and FIG. 6 show run-time GUI's that display script information to a user, such as a call-center agent.

Referring to FIG. 2, a design-time GUI 250 displays a script graph having script nodes 252, 254, and 256. These nodes define an overall design and structure of a script that may later be used during an interaction with a person at run time. Various additional nodes could be added to the script graph to extend the design and scope of the script, as needed. In FIG. 2, the script graph includes only the three nodes 252, 254, and 256. The node 252 is a dialogue node that is labeled “TRANSLATION_SAMPLE_Q1”. The information and text associated with this node will be farther described in FIG. 3A. The node 254 is a button node, indicating that a button is to be displayed at run time. When the button is selected, control is passed to the node 256, which is another dialogue node that is labeled “TRANSLATION_SAMPLE_Q2”. The information and text associated with this node will be further described in FIG. 3B.

Referring to FIG. 3A, a design-time GUI 200 displays script information for the node 252 in English. In one embodiment, a script designer uses GUI 200 to design an interactive script. The node 252 shown in FIG. 3A includes the screen areas 202 and 204. The screen area 202 includes question information, in textual form, that is to be used within the script. The screen area 204 includes data entry and selection fields that are also to be used within the script.

A user, such as a script designer, may enter textual information into screen area 202 as question information for the interactive script. For example, as shown in FIG. 3A, a user has entered the text 206A as a question in English. The user may also create data entry and selection fields in the screen area 204. The fields 218 and 220 are data entry fields, and the fields 222, 224, and 226 are selection fields. Each of the fields is associated with textual information. The text 208A is associated with the data entry field 218, and the text 210A is associated with the data entry field 220. The text 212A is associated with the selection field 222, the text 214A is associated with the selection field 224, and the text 216A is associated with the field 226. In one scenario, a user, such as a call-center agent, could read the text shown in 206A, 208A, 210A, 212A, 214A, and/or 216A to obtain information from a customer for entry in the fields 218, 220, 222, 224, and/or 226.

As shown in FIG. 3A, the textual information shown in the screen areas 202 and 204 is represented in English. In other embodiments, however, the textual information could be represented in any number of different languages.

FIG. 3B is an example of a design-time GUI 300 to display additional script text for the node 256 in English. The node 256 shown in FIG. 3B includes a screen area 302. The text 304A shown in the screen area 302 may be used as part of an interactive script. In one embodiment, the text 304A is used as a script conclusion in coordination with the other script textual information shown in FIG. 3A. In this embodiment, a script designer may enter the text 304A into the screen area 302 during design of the interactive script.

As shown in FIG. 3B, the textual information shown in the screen area 302 is represented in English. In other embodiments, however, the textual information could be represented in any number of different languages.

FIG. 4 is an example of a design-time GUI 400 to display script translation information. Using the GUI 400, a script designer can provide translation information for each element of an interactive script. Because each script element is shown, the designer does not have to worry about using multiple translation screens or forgetting to translate a particular element of the script.

The GUI 400 includes a screen area 410, which contains a script identifier field 412, a source language menu 414, a target language menu 416, and a load button 418. The script identifier field 412 indicates the name of the script. Once a translated script has been created with this name, it can be saved and retrieved for later use. The source language menu 414 and the target language menu 416 provide lists of source and target languages, respectively. The script designer may select the source language of the original script text using the source language menu 414, and may then select the target language for the translated script text using the target language menu 416. As shown in the example in FIG. 4, the source and target language menus 414 and 416 are pull-down menus. Once the source and target languages are chosen, the load button 418 may be utilized to load and display the script text into a screen area 402 for translation.

In the example shown in FIG. 4, the screen area 402 contains three distinct columns of information for displaying the original and translated scripts. A column 404 displays the element types for each of the original and translated scripts. A column 406 contains script areas for displaying the text for the original script in English, and a column 408 contains script areas for displaying the text for the translated script in Spanish. The element types listed in the column 404 are the complete set of element types for both the original and translated scripts, from start to finish. That is, the element types for these scripts that are associated with script areas for displaying text are listed in the column 404. As shown in the example in FIG. 4, the original and translated scripts each contain text for a script title, a set of chapter titles, a button, a set of step descriptions, a set of question text, a set of text fields, and a set of radio buttons. Some of these element types are shown in the previous FIG. 3A and FIG. 3B.

The original text for each element type is shown in the column 406. The text is loaded into the column 406 when the script designer selects the load button 418. The text shown in the column 406 is part of the original English script. Various portions of the English text have already been shown in FIG. 3A and FIG. 3B. For example, the text 206A, 208A, 210A, 212A, 214A, and 216A are shown in FIG. 3A. The text 304A is shown in FIG. 3B. As shown in the screen area 402, every portion of English text that is associated with the original English script is shown in the column 406, and each portion is associated with a specific element type. For example, the text 420A is associated with the “Button” element type. The text 206A is associated with the “Question Text” element type. The text 208A is associated with the “Text Field” element type. The text 210A is associated with the “Text Field” element type. The text 212A is associated with the “Radio Button” element type. The text 214A is associated with the “Radio Button” element type. And the text 216A is associated with the “Radio Button” element type.

The translated text for each element type is shown in the column 408. The text shown in the column 408 is part of the translated Spanish script. In one embodiment, default Spanish text that has been previously entered and saved may be loaded into the column 408 when the script designer selects the load button 418. In one embodiment, the default Spanish text is shown in the column 408 as read-only, and cannot be modified or deleted. Because the column 408 is shown adjacent to the column 406 in the screen area 402, the script designer can easily associate each row of translated Spanish text with the corresponding row of original English text. Each row is also associated with the corresponding element type shown for that row. For example, the text 420B contains the Spanish translation of the text 420A, and is associated with the element type “Button.” The text 206B contains the Spanish translation of the text 206A, and is associated with the element type “Question Text.” The text 208B contains the Spanish translation of the text 208A, and is associated with the element type “Text Field.” The text 210B contains the Spanish translation of the text 210A, and is associated with the element type “Text Field.” The text 212B contains the Spanish translation of the text 212A, and is associated with the element type “Radio Button.” The text 214B contains the Spanish translation of the text 214A, and is associated with the element type “Radio Button.” The text 216B contains the Spanish translation of the text 216A, and is associated with the element type “Radio Button.” The text 304B contains the Spanish translation of the text 304A, and is associated with the element type “Question Text.”

Once the script designer has entered all of the translated Spanish text into the column 408, the translated script may be saved. In one embodiment, the GUI 400 will not allow the translated script to be saved unless each of the rows in the column 408 contain Spanish text. This prevents the script designer from inadvertently forgetting to enter translated text for one or more of the associated element types.

In one embodiment, the script designer may select individual portions of text shown in the columns 406 and/or 408 to view appropriate portions of the script graph shown in FIG. 2. For example, the script designer could use a pointing device to select, or click on, the text 206A or 206B. When this text is selected, the GUI 250 in FIG. 2 will then be displayed to the designer, and the node 252 of the script graph will be highlighted. The highlighted node 252 is associated with the text 206A and 206B that was previously selected by the designer. Similarly, if the designer selects the text 304A or 304B, the GUI 250 will be displayed with the node 256 being highlighted. The designer may then select any of the nodes to view the script details for that node. For example, if the designer selects the node 252, the GUI 200 shown in FIG. 3A will be displayed for the node 252. If the designer selects the node 256, the GUI 300 shown in FIG. 3B will be displayed for the node 256. In this fashion, the designer may navigate through various screens according to the original or translated text that is selected.

The example shown in the GUI 400 displays a Spanish translation of English script text. Of course, FIG. 4 shows only one example of the types of languages that could be used in the translation process. Any number of different translations may be provided. In addition, the relative positions of columns 404, 406, and 408 may be oriented differently in other embodiments of the invention.

FIG. 5 is an example of a run-time GUI 500 to display a script to a call-center agent in English. The English text is displayed in the GUI 500 based on the text provided in the column 406 shown in FIG. 4. During run time, the call-center agent is capable of reading the script displayed in the GUI 500 to an English-speaking customer based on the script developed at design time.

A screen area 502 displays the details of the run-time script in English. The script includes the text 206A. By reading the text 206A during a call with a customer, the call-center agent is able to provide an introduction, and then ask the customer if the agent may ask a few questions about calling needs. The agent may then read the text 208A to ask which state in the U.S. the customer calls the most. After receiving an answer from the customer, the agent may input the answer into the data entry field 218. The agent may then read the text 210A to ask which country the customer calls the most, and inputs the customer's answer into the data entry field 220. Finally, the agent may read the text 212A, 214A, and 216A to determine when the customer makes most of his/her calls. Depending on the answer, the agent will select one of the fields 222, 224, or 226. After the agent has finished reading the script text shown in the screen area 502 and capturing the customer's input data, the agent can click on a button 504 to continue with the interaction. The text 420A shown on the button 504 is displayed in English.

FIG. 6 is an example of a run-time GUI 600 to display the script shown in FIG. 5 translated into Spanish. The Spanish text is displayed in the GUI 600 based on the text provided in the column 408 shown in FIG. 4. During run time, the call-center agent is capable of reading the script displayed in the GUI 600 to a Spanish-speaking customer based on the translated script developed at design time. The translated script shown in the screen area 502 includes translated text 206B, 208B, 210B, 212B, 214B, and 216B. The screen area 502 also shows the translated text 420B on the button 504.

FIG. 7 shows a block diagram of a computing system that can be utilized for displaying the various GUI's shown in FIG. 1 through FIG. 6, according to one embodiment. The system 700 includes a processor 702, a memory 704, a storage device 706, and an input/output device 708. Each of the components 702, 704, 706, and 708 are interconnected using a system bus. The processor 702 is capable of processing instructions for execution within the system 700. In one embodiment, the processor 702 is a single-threaded processor. In another embodiment, the processor 702 is a multi-threaded processor. The processor 702 is capable of processing instructions stored in the memory 704 or on the storage device 706 to display graphical information for a GUI on the input/output device 708.

The memory 704 stores information within the system 700. In one embodiment, the memory 704 is a computer-readable medium. In one embodiment, the memory 704 is a volatile memory unit. In another embodiment, the memory 704 is a non-volatile memory unit.

The storage device 706 is capable of providing mass storage for the system 700. In one embodiment, the storage device 706 is a computer-readable medium. In various different embodiments, the storage device 706 may be a floppy disk device, a hard disk device, an optical disk device, or a tape device.

The input/output device 708 provides input/output operations for the system 700. In one embodiment, the input/output device 708 includes a keyboard and/or pointing device. In one embodiment, the input/output device 708 includes a display unit for displaying the GUI's shown in FIG. 1 through FIG. 6.

A number of embodiments of the invention have been described. Nevertheless, it will be understood that various modifications may be made without departing from the spirit and scope of the invention. Accordingly, other embodiments are within the scope of the following claims.

1. A graphical user interface (GUI) for use by a designer in preparing a translation of a script that may later be displayed to and read by a user during an interactive session with another person, the GUI comprising:
a first set of script areas that are each capable of providing a textual display of a distinct portion of the script in a first language; and
a second set of script areas that are each capable of providing a textual display of a distinct portion of the script in a second language,
wherein each script area in the first set has a spatial relationship with a script area in the second set that corresponds to the same distinct portion of the script.

2. The GUI of claim 1, wherein the GUI further comprises:
a menu area capable of displaying a set of selectable language options for determining the second language.

3. The GUI of claim 1, wherein the GUI further comprises:
a selectable save option to save the script in the second language when text associated with each distinct portion of the script is displayed in the second set of script areas.

4. The GUI of claim 1, wherein at least one of the script areas in the second set is capable of displaying default text in the second language that has been previously saved.

5. The GUI of claim 1, wherein at least one of the script areas in the second set is capable of displaying read-only text in the second language.

6. The GUI of claim 1, wherein at least one of the script areas in the second set is capable of displaying text in the second language that has been input by the designer.

7. The GUI of claim 1, wherein each distinct portion of the script is associated with a script element type.

8. The GUI of claim 1, wherein at least one of the script areas in the first or second set includes a selectable area that, when selected, causes a corresponding portion of a script graph for the script to be displayed using the GUI.

9. The GUI of claim 1, wherein the portions of the script include a script introduction, a script question, and a script conclusion.

10. The GUI of claim 1, wherein a script area in the first set that is associated with a particular portion of the script is adjacent to a script area in the second set that is also associated with the particular portion of the script.

11. A computer-implemented method for using a graphical user interface (GUI) to prepare a translation of a script that may later be displayed to and read by a user during an interactive session with another person, the method comprising:
providing a first screen area to display the script in a first language, wherein the first screen area includes script areas that are associated with each distinct portion of the script that could be read by the user to another person during the interactive session; and
providing a second screen area to display the script in a second language, wherein the second screen area includes script areas that are each associated with one of the script areas of the first screen area.

12. The computer-implemented method of claim 11, wherein the method further comprises:
providing a menu area to display a set of selectable language options for determining the second language.

13. The computer-implemented method of claim 11, wherein the method further comprises:
providing an option to save the script in the second language when text associated with each distinct portion of the script is displayed in the second screen area.

14. The computer-implemented method of claim 11, wherein the method comprises:
providing a second screen area to display the script in a second language, such that at least one of the script areas in the second screen area displays default text in the second language that has been previously saved.

15. The computer-implemented method of claim 11, wherein the method comprises:
providing a second screen area to display the script in a second language, such that at least one of the script areas in the second screen area displays text in the second language that has been input by a script designer.

16. The computer-implemented method of claim 11, wherein the method comprises: providing a second screen area to display the script in a second language, such that at least one of the script areas in the second screen area displays read-only text in the second language.

17. The computer-implemented method of claim 11, wherein the method comprises:
providing a second screen area that is adjacent to the first screen area.

18. The computer-implemented method of claim 11, wherein a script area in the first screen area that is associated with a particular portion of the script is adjacent to a script area in the second screen area that is also associated with the particular portion of the script.

19. The computer-implemented method of claim 11, wherein each distinct portion of the script is associated with a script element type.

20. The computer-implemented method of claim 11, wherein at least one of the script areas in the first or second screen areas includes a selectable area that, when selected, causes a corresponding portion of a script graph for the script to be displayed using the GUI.

21. The computer-implemented method of claim 11, wherein the portions of the script include a script introduction, a script question, and a script conclusion.

22. The computer-implemented method of claim 11, wherein the user is a call-center agent and the other person is a customer.

23. A computer-readable medium having computer-executable instructions contained therein to perform a method for using a graphical user interface (GUI) to prepare a translation of a script that may later be displayed to and read by a user during an interactive session with another person, the method comprising:
providing a first screen area to display the script in a first language, wherein the first screen area includes script areas that are associated with each distinct portion of the script that could be read by the user to another person during the interactive session; and
providing a second screen area to display the script in a second language, wherein the second screen area includes script areas that are each associated with one of the script areas of the first screen area.

24. A computing system for use by a designer in preparing a translation of a script that may later be displayed to and read by a user during an interactive session with another person, such that the computing system is programmed to:
provide a first screen area to display the script in a first language on a display device, wherein the first screen area includes script areas that are associated with each distinct portion of the script that could be read by the user to another person during the interactive session; and
provide a second screen area to display the script in a second language on the display device, wherein the second screen area includes script areas that are each associated with one of the script areas of the first screen area.
